(19) United States
(12) Patent Application Publication
(10) Pub. No.: US 2025/0118018 A1
(43) Pub. Date: Apr. 10, 2025

(54) METHOD, APPARATUS, DEVICE, AND STORAGE MEDIUM FOR ENVIRONMENT CALIBRATION

(71) Applicant: Beijing Zitiao Network Technology Co., Ltd., Beijing (CN)

(72) Inventor: Zijian WANG, Beijing (CN)

(21) Appl. No.: 18/802,659

(22) Filed: Aug. 13, 2024

(30) Foreign Application Priority Data
Oct. 8, 2023 (CN) 202311293957.5

(51) Int. Cl. G06T 17/00; G06T 7/70; G06V 10/44

(52) U.S. Cl. CPC G06T 17/00; G06T 7/70; G06V 10/44

(57) ABSTRACT

Embodiments of the application provide a method, apparatus, device, and storage medium for environment calibration. The method includes: at an electronic device configured to communicate with a display generation component and one or more input devices: displaying, via the display generation component, a three-dimensional computer-generated environment; determining, in the three-dimensional computer-generated environment, calibration composition data of a target physical object in a computation coordinate system; and determining a calibration model of the target physical object in a rendering coordinate system used for calibration, based on the calibration composition data and a coordinate offset between the computation coordinate system and the rendering coordinate system.

### CROSS REFERENCE

The present application claims priority to Chinese Patent Application No. 202311293957.5, filed on Oct. 8, 2023 and entitled “METHOD, APPARATUS, DEVICE, AND STORAGE MEDIUM FOR ENVIRONMENT CALIBRATION”, the entirety of which is incorporated herein by reference.

### FIELD

Embodiments of the present application relate to the technical field of data processing, in particular to a method, apparatus, device and storage medium for environment calibration.

### BACKGROUND

At present, the application scenario of extended reality (abbreviated as XR) technology is more and more extensive, and the XR technology specifically includes virtual reality (abbreviated as VR), augmented reality (abbreviated as AR), and mixed reality (abbreviated as MR). In a virtual scene, the entire real environment may need to be calibrated to construct a calibration model of each physical object in the real environment, so as to achieve the interactive effect of combining reality and virtuality based on the calibration models of various physical objects.

When constructing the calibration model of each physical object, the calibration model may be affected by various environment parameters of the real environment and camera viewing angles. However, due to the fact that different application coordinate systems can be used to provide user interaction in various virtual scenes, different environment parameters will be set in respective application coordinate systems for the same real environment, resulting in differences in the environment parameters used for calibrating various physical objects. This leads to a certain deviation between the calibration model position of the physical object and the actual position, and the accuracy of calibrating various physical objects in the real environment may not be guaranteed.

### SUMMARY

Embodiments of the present application provide a method, apparatus, device and storage medium for environment calibration, which realizes accurate calibration of a target physical object and ensures environment calibration adaptability in a plurality of scene coordinate systems.

In a first aspect, embodiments of the present application provides a method of environment calibration, including:
at an electronic device configured to communicate with a display generation component and one or more input devices:
displaying, via the display generation component, a three-dimensional computer-generated environment;
determining, in the three-dimensional computer-generated environment, calibration composition data of a target physical object in a computation coordinate system; and
determining a calibration model of the target physical object in a rendering coordinate system used for calibration, based on the calibration composition data and a coordinate offset between the computation coordinate system and the rendering coordinate system.

In a second aspect, embodiments of the present application provides an apparatus for environment calibration, including:
at an electronic device configured to communicate with a display generation component and one or more input devices:
an environment display module configured to display, via the display generation component, a three-dimensional computer-generated environment;
a calibration data determination module configured to determine, in the three-dimensional computer-generated environment, calibration composition data of a target physical object in a computation coordinate system; and
a physical object calibration module configured to determine a calibration model of the target physical object in a rendering coordinate system used for calibration, based on the calibration composition data and a coordinate offset between the computation coordinate system and the rendering coordinate system.

In a third aspect, embodiments of the present application provides an electronic device, including:
a processor and a memory configured to store a computer program, wherein the processor is configured to invoke and run the computer program stored in the memory to perform the method of environment calibration provided in the first aspect of the present application.

In a fourth aspect, embodiments of the present application provide a computer-readable storage medium storing a computer program, wherein the computer program causes a computer to perform the method of environment calibration provided in the first aspect of the present application.

In a fifth aspect, embodiments of the present application provides a computer program product including a computer program/instruction, which, when executed by a processor, implements the method of environment calibration provided in the first aspect of this application.

According to the technical solution provided by embodiments of the present application, the three-dimensional computer-generated environment is displayed via the display generation component of the electronic device, and calibration composition data of any target physical object in the computation coordinate system is determined in the three-dimensional computer-generated environment. Then, the calibration model of the target physical object in the rendering coordinate system used for calibration is determined based on the calibration composition data and the coordinate offset between the computation coordinate system and rendering calibration, so that accurate calibration of any target physical object is achieved, environment calibration adaptability in different application coordinate systems used in various scenes is ensured, position deviation occurring during environment calibration in different application coordinate systems is avoided, and the authenticity and effectiveness of environment calibration is improved.

### BRIEF DESCRIPTION OF DRAWINGS

In order to more clearly illustrate the technical solutions in the embodiments of the present application, the accompanying drawings that need to be used in the description of the embodiments are briefly described below. Obviously, the drawings in the following description are merely some embodiments of the present application, and for those of ordinary skill in the art, other drawings may be obtained based on these drawings without creative work.

FIG. 1 is a flowchart of a method of environment calibration according to embodiments of the present application;

FIG. 2 is a flowchart of another method of environment calibration according to embodiments of the present application;

FIG. 3 is an example schematic diagram of calibration composition data of a target physical object according to embodiments of the present application;

FIG. 4 is a schematic block diagram of an apparatus for environment calibration according to embodiments of the present application; and

FIG. 5 is a schematic block diagram of an electronic device according to embodiments of the present application.

### DETAILED DESCRIPTION

The technical solutions in the embodiments of the present application are clearly and completely described below with reference to the accompanying drawings in embodiments of the present application. All other embodiments obtained by those skilled in the art without creative efforts shall fall within the scope of the present application.

It should be noted that the terms “first”, “second”, and the like in the specification and claims of the present application and the foregoing drawings are used to distinguish similar object and are not necessarily used to describe a specific order or sequence. It should be understood that such used data may be interchanged where appropriate so that embodiments of the present application described herein can be implemented in an order other than those illustrated or described herein. Moreover, the terms “comprising”, “having” and their variations are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In embodiments of the present application, words such as “in an example” or “for example” are used to indicate examples, illustrations, or descriptions, and any embodiment or solution described as “in an example” or “for example” in the embodiments of the present application should not be construed as being more preferred or advantageous than other embodiments or solutions. Rather, words such as “in an example” or “for example” are intended to present related concepts in a specific manner.

Before describing a specific technical solution of the present application, the application scenario of the present application is first described correspondingly.

In order to achieve accurate calibration of an object in the virtual reality environment, the present application may construct a virtual reality environment through a computer in advance as the three-dimensional computer-generated environment in the present application. Then, at any electronic device configured to communicate with a display generation component and the one or more input devices, the corresponding three-dimensional computer-generated environment may be displayed by the display generation component of the electronic device, so that the user enters into the three-dimensional computer-generated environment to perform a corresponding calibration operation on each physical object in the three-dimensional computer-generated environment.

The electronic device may be any XR device, and may specifically include a VR device, an AR device, and a MR device, which is not limited in the present application.

The display generation component may be any display screen or the like that is in communication connection with the electronic device. For example, the display generation component may be a display screen configured on the VR device, the AR device, or the MR device, which is not limited in the present application.

Moreover, in order to achieve the normal interaction of the user in the three-dimensional computer-generated environment, the user may initiate a corresponding interaction operation on various types of information in the three-dimensional computer-generated environment displayed by the display generation component through one or more input devices in communication with the electronic device, thereby enabling the user to perform various information interactions in the three-dimensional computer-generated environment.

The one or more input devices may be any control device and information collection device that establish a communication connection with the electronic device. For example, the one or more input devices may be a handle configured on the VR device, the AR device or the MR device, or a collection module configured to detect hand operations, eye movement information, or a voice collector configured to collect user voice information, which are not limited in the present application.

At present, in order to solve the problem that the position deviation occurs in a real environment calibration due to the fact that the same real environment can set different environment parameters in different application coordinate systems when different application coordinate systems are used for providing user interaction in a plurality of scenes, the inventive concept of the present application is to determine calibration composition data of any target physical object in a computation coordinate system in a three-dimensional computer-generated environment, and determine a calibration model of the target physical object in the rendering coordinate system used for calibration, based on the calibration composition data and a coordinate offset between the computation coordinate system and rendering coordinate system. Therefore, the accurate calibration of any target physical object is achieved, and the authenticity and effectiveness of environment calibration is improved.

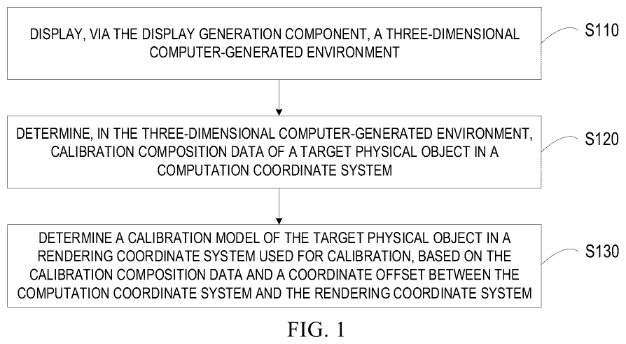

FIG. 1 is a flowchart of a method of environment calibration according to embodiments of the present application, and the method may be applied to a XR device but is not limited to this. The method may be performed by an apparatus for environment calibration provided in the present application, where the apparatus for environment calibration may be implemented in any software and/or hardware manner. In an example, the apparatus for environment calibration may be configured in an electronic device capable of simulating a virtual scene, such as an AR/VR/MR, and the specific types of the electronic device are not limited in the present application.

Specifically, as shown in FIG. 1, the method may include the following steps:

At S110, a three-dimensional computer-generated environment is displayed via the display generation component.

The three-dimensional computer-generated environment may be a corresponding virtual environment simulated by the electronic device for a certain interactive scene selected by any user, or a corresponding real environment captured by the electronic device enabling a video see-through (abbreviated as VST) function, so that various interactive information is displayed in the three-dimensional computer-generated environment.

In the present application, the three-dimensional computer-generated environment may include, but is not limited to, the following three types:

### 1) A Pure Fictional Virtual Scene

The computer may build a pure virtual space under various types in advance, and the pure virtual space includes various pure fictional virtual objects to form a pure virtual scene.

For example, a pure fictional performance space of a bar may be established, and a virtual person representing a performer, a virtual person representing a viewer, and a virtual object representing various objects in the bar may be included in the whole pure fictional performance space.

### 2) A Captured Real Environment

By enabling the VST function configured by the electronic device, the real environment in which the user is currently located can be captured in real time, so that the real environment image where the user is located is continuously collected and presented via a display.

### 3) A Semi-Fictional Semi-Simulation Scene Fused by a Virtual Environment and a Real Environment

By enabling the VST function configured by the electronic device, the real environment in which the user is currently located can be captured in real time, so that the real environment image where the user is located is continuously collected and presented via a display. Moreover, the computer may construct the corresponding virtual object in advance, and further display the virtual object while displaying the real environment image via the display, so as to achieve the fusion of the virtual object and the real environment. Then, the semi-fictional semi-simulation scene fused by the virtual environment and the real environment may be presented via the display.

In an example, the semi-fictional semi-simulation scene in the present application may be a mixed reality (MR) space generated by using MR technology.

### 4) Live Stream Interaction Scene Composed of a Video Playing Field and a Unity Interaction Field

In order to ensure that a user experiences a space feeling and a three-dimensional feeling of three-dimensional live stream interaction in a virtual reality environment, a live stream interaction scene composed of a video playing field of 3D and a Unity interaction field may be specially constructed as the virtual reality environment in the present application.

The Unity interaction field may be used to present various virtual objects constructed by the user for the corresponding live stream scene by using the Unity engine, so as to support the user to control a virtual controller to generate a corresponding interactive operation with each virtual object. The video playing field may be used to present a live video stream of any live stream room that the user wants to watch, and an interaction effect generated after the user performs various interactive operations on each virtual object.

As can be seen from the above content that, after the three-dimensional computer-generated environment is determined, the three-dimensional computer-generated environment may be displayed through a display generation component in communication connection with the electronic device, so that the user enters into the three-dimensional computer-generated environment. The display generation component may be any display screen, for example, a display screen and the like configured on the VR device, the AR device, or the MR device.

At S120, calibration composition data of a target physical object in a computation coordinate system is determined in the three-dimensional computer-generated environment.

In order to achieve accurate calibration of the three-dimensional computer-generated environment, the present application may integrate the real scene with the virtual content to create a human-computer interactive virtual environment that combines virtual and real elements, for example, a virtual object mounted on a wall of the real environment. Therefore, after the user wears the electronic device, a video see-through (VST) function configured on the electronic device may be enabled to perform real-time shooting on the surrounding real environment where the user is currently located, so as to continuously collect the real environment image in the real scene where the user is located. Then, through the above display generation component, the collected various real environment images may be displayed to the user, so that the three-dimensional computer-generated environment may be presented in front of the user.

It can be understood that, in order to ensure the interaction fidelity for the user in the three-dimensional computer-generated environment, each real object usually needs to be calibrated in the three-dimensional computer-generated environment, so that the virtual model after the real object is calibrated may maintain consistent alignment with the real object, thereby supporting the user in performing corresponding interaction operation on the virtual model, and achieving various interactions in the three-dimensional computer-generated environment.

The target physical object in the present application may be any physical object that exits in the real environment, including but not limited to a wall surface, a ground surface, a door and a window, a ceiling, various furniture and the like in a real environment.

When any target physical object is calibrated, it is usually necessary to perform corresponding recognition processing on a large amount of environmental data in a real environment where the target physical object is located, so as to analyze relevant pose information of the target physical object. The environment data may be point cloud scanning data of a real environment, a scene image, annotation information generated manually or automatically annotating a boundary of a real environment and an obstacle, and the like.

A specific coordinate system is used at the back end of the electronic device to process the environmental data in the real environment to analyze the relevant pose information of the target physical object. Therefore, the present application may use the specific coordinate system used when the backend performs processing on the environmental data as the computation coordinate system in the present application.

In some implementations, the physical object calibration in the three-dimensional computer-generated environment may be understood as map construction of a real environment in which the physical object is located and may be implemented by using a Simultaneous Localization and Mapping (SLAM) system. Therefore, the computation coordinate system in the present application may be a system coordinate system in the SLAM system, for example, a world coordinate system.

Moreover, after each physical object is calibrated, the virtual model after calibration of the physical object is usually rendered and displayed in a front end interface (for example, the display generation component) of the electronic device. In order to support a real interaction effect of a plurality of scenes, a plurality of application coordinate systems are usually configured in advance, so that a matched application coordinate system may be used in each scene to render specific scene content in the scene.

Each application coordinate system may include but is not limited to a coordinate system at an eye level, a floor level, a stage Level, and the like.

In any scene, one of a plurality of pre-configured application coordinate systems may be selected to achieve accurate presentation of the front-end scene content.

In order to ensure accuracy of calibration of the physical object, in the present application, before calibrating the physical object, a plurality of pre-configured application coordinate systems are determined firstly, and a coordinate offset between the computation coordinate system and each application coordinate system is recorded.

That is, before the physical object is calibrated, in the present application, a plurality of pre-configured application coordinate systems are determined firstly. Then, in the initialization stage, the coordinate origins of the computation coordinate system and each application coordinate system, and the coordinate offset between the computation coordinate system and each application coordinate system may be recorded, so that when interacting in the three-dimensional computer-generated environment, the user input parameter of the front end and the algorithm recommendation data of the back end can be normalized to ensure accurate interaction in the three-dimensional computer-generated environment.

In an embodiment, the coordinate offset between the computation coordinate system and each application coordinate system in the present application may be stored in a runtime stage.

Based on the above content, after the display generation component of the electronic device presents the three-dimensional computer-generated environment where the user is currently located to the user, whether a corresponding calibration request is initiated for the three-dimensional computer-generated environment may be detected in real time. After detecting that the user initiates an operation on the calibration request for the three-dimensional computer-generated environment, in order to ensure the calibration accuracy of the physical object, the computation coordinate system and the rendering coordinate system used for calibration may be first determined. The rendering coordinate system may be one by the user from the plurality of pre-configured application coordinate systems when the real environment is calibrated.

Moreover, in the coordinate offset between the computation coordinate system and each application coordinate system recorded in advance, the coordinate offset between the computation coordinate system and the rendering coordinate system may be directly found, so as to achieve normalization processing for the user input parameter and the back-end calibration data when the physical object is calibrated, thereby ensuring accurate calibration of the physical object.

The calibration composition data of each physical object may be related pose information of the physical object in the real environment, including but not limited to a position, an orientation, an object size, a spatial shape, and the like of the physical object in the real environment.

In the present application, when the three-dimensional computer-generated environment is calibrated, an entire three-dimensional scene of the real environment in which the target physical object is located may first be scanned to obtain three-dimensional scene data corresponding to the real environment. For example, a scene image of a real environment is captured by a camera on the electronic device, or three-dimensional point cloud data in the real environment is obtained by laser radar scanning.

Then, the computation coordinate system used by the backend data processing is used to perform corresponding processing analysis on the three-dimensional scene data corresponding to the real environment to determine relevant pose information of any target physical object in the real environment. Therefore, calibration composition data of the physical object in the computation coordinate system is obtained, to represent pose information of the physical object in the computation coordinate system after calibration.

At S130, a calibration model of the target physical object in a rendering coordinate system used for calibration is determined, based on the calibration composition data and a coordinate offset between the computation coordinate system and the rendering coordinate system.

After the calibration composition data of any target physical object in the computation coordinate system is determined in the three-dimensional computer-generated environment, since the virtual model after the physical object calibration needs to be presented in the rendering coordinate system used by the front end, in order to avoid the situation that the calibration position of the physical object deviates due to the inconsistency of the computation coordinate system and the rendering coordinate system, in the present application, a coordinate transformation may be performed on the calibration composition data by using the coordinate offset between the computation coordinate system and the rendering coordinate system, to determine pose information of the target physical object in the rendering coordinate system.

Then, according to the pose information of the physical object in the rendering coordinate system, the virtual model after the physical object is calibrated may be generated as the calibration model of the physical object in the present application.

According to the foregoing same manner, the coordinate offset between the computation coordinate system and the rendering coordinate system may be used to continuously perform corresponding pose coordinate transformation on the calibration composition data of each target physical object in the real environment in the computational coordinate system to determine the calibration model of each target physical object in the rendering coordinate system, so as to achieve the accuracy and comprehensiveness of environment calibration.

According to the technical solution provided by the embodiment of the present application, the three-dimensional computer-generated environment is displayed via the display generation component of the electronic device, and calibration composition data of any target physical object in the computation coordinate system is determined in the three-dimensional computer-generated environment. Then, the calibration model of the target physical object in the rendering coordinate system is determined according to the calibration composition data and the coordinate offset between the computation coordinate system and the rendering coordinate system used for calibration, so that accurate calibration of any target physical object is achieved, environment calibration adaptability in different application coordinate systems used in various scenes is ensured, position deviation occurring during environment calibration in different application coordinate systems is avoided, and the authenticity and effectiveness of environment calibration is improved.

As an optional implementation solution of the present application, to ensure the calibration accuracy of the physical object, it is required that the calibration composition data of any target physical object can accurately represent the pose of the target physical object in the real environment, so that the virtual model (that is, the calibration model of the physical object) after calibrating the physical object may be consistent with the physical object.

Therefore, the specific determining process of the calibration composition data of any target physical object and the specific determining process of the calibration model of the target physical object may be described in detail in the present application.

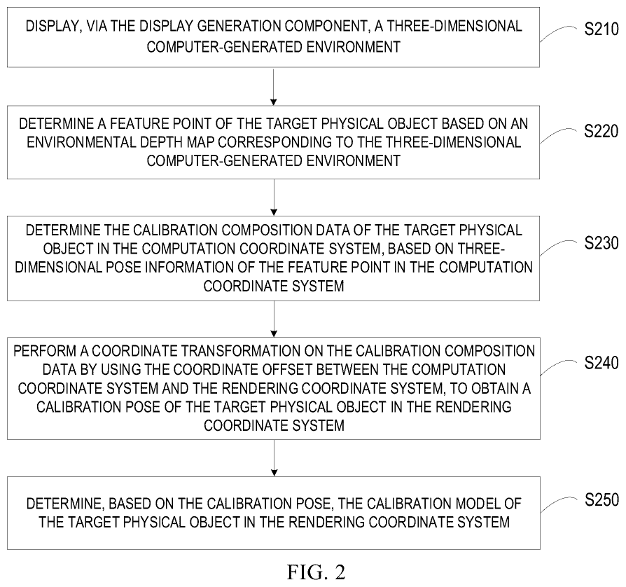

FIG. 2 is a flowchart of another method for environment calibration according to embodiments of the present application. As shown in FIG. 2, the method may specifically include the following steps:

At S210, a three-dimensional computer-generated environment is displayed via the display generation component.

At S220, a feature point of the target physical object is determined based on an environmental depth map corresponding to the three-dimensional computer-generated environment.

In order to accurately analyze information of the physical object to be calibrated in the three-dimensional computer-generated environment, in the present application, real-time shooting on the real environment may be performed through a camera configured on the electronic device to continuously obtain the real environmental depth map as the environmental depth map corresponding to the three-dimensional computer-generated environment. The environmental depth map may include at least one physical object. Then, respective feature points of any target physical object may be extracted from the environmental depth map by performing a corresponding feature analysis on the environmental depth map.

In some implementations, a large amount of environment images may be used as training samples to pre-train a feature extraction model to extract feature points in any environment image. Then, in the present application, the environmental depth map corresponding to the three-dimensional computer-generated environment may be input into the pre-trained feature extraction model, and corresponding feature analysis is performed on the environmental depth map by using the feature extraction model, thereby outputting respective feature points of any target physical object in the environmental depth map.

In some other implementations, in the present application, a corresponding grayscale processing may be performed on the environmental depth map corresponding to the three-dimensional computer-generated environment to convert the environmental depth map into a corresponding environment grayscale image. Then, considering that the feature point of any target physical object may be a pixel with a drastic change in the grayscale value in the image, in the present application, kernel value similarity analysis may be performed on the grayscale value of respective pixels in the environment grayscale image to preset a grayscale threshold. Further, a target pixel with a grayscale value greater than the grayscale threshold may be extracted from the environmental grayscale image as respective feature points of the target physical object.

The feature point of the target physical object in the present application may be a corner point or respective constituent points on the edge line of the target physical object, thereby representing a spatial structure of the target physical object.

As an optional implementation solution of the present application, because the spatial mapping between the real environment and the virtual scene is complex, the actual environmental information of the real environment and the camera viewing angle during shooting of the environmental depth map may affect the semantic recognition of the physical object in the environmental depth map, and the feature extraction accuracy of the physical object may not be ensured.

Therefore, for the feature point of any target physical object, in the present application, which may be determined by the following steps: performing feature analysis on the environmental depth map corresponding to the three-dimensional computer-generated environment, based on a target environment parameter of the three-dimensional computer-generated environment in the computation coordinate system, to obtain the feature point of the target physical object.

The target environment parameter is determined by an environment input parameter when the rendering coordinate system is selected, and a coordinate offset between the computation coordinate system and the rendering coordinate system.

That is, when one of the multiple application coordinate systems is selected as the rendering coordinate system, the front-end interface usually displays the corresponding environment parameter setting prompt to the user, so as to prompt the user to set the corresponding environment parameter for the real environment where the user is currently located in advance for the selected rendering coordinate system, thereby obtaining the environment input parameter when the rendering coordinate system is selected. The environment input parameter may include, but is not limited to, information such as a ground height, a ceiling height, an obstructed wall angle point and the like set by the user for the real environment where the user is currently located. Data formats and contents of the environment input parameter in different application coordinate systems are different.

Because the feature point of the target physical object is obtained by processing the environmental depth map in the computation coordinate system used by the back end, in order to ensure the accuracy of feature extraction of the target physical object, in the present application, the coordinate offset between the computation coordinate system and the rendering coordinate system may be used to perform corresponding coordinate transform on the environment input parameter when the rendering coordinate system is selected, to obtain the target environment parameter of the three-dimensional computer-generated environment in the computation coordinate system. The target environment parameter may represent actual environmental information available for the three-dimensional computer-generated environment in the computation coordinate system.

Then, according to the general spatial structure information indicated by the target environment parameter for the three-dimensional computer-generated environment, corresponding feature analysis may be performed on each physical object in the environmental depth map corresponding to the three-dimensional computer-generated environment, to respective various feature points of the target physical object, and determine three-dimensional pose information of respective feature points in the three-dimensional computer-generated environment.

At S230, the calibration composition data of the target physical object in the computation coordinate system is determined, based on three-dimensional pose information of the feature point in the computation coordinate system.

After determining respective feature points of any target physical object, respective feature points of each target physical object may be combined into a general shape of the target physical object. Therefore, by performing fusion analysis on the three-dimensional pose information of respective feature points in the computation coordinate system, relevant pose information such as a position, an orientation, an object size, a spatial shape, and the like of the target physical object in the computation coordinate system may be determined, thereby obtaining calibration composition data of the target physical object in the computation coordinate system.

In some implementations, for the calibration composition data of any target physical object in the computational coordinate system, in the present application, which may be determined by the following steps: determining a calibration representation of the target physical object based on the three-dimensional pose information of the feature point in the computation coordinate system; and determining, based on the calibration representation, at least one spatial anchor point of the target physical object and boundary information associated with the spatial anchor, to constitute the calibration composition data of the target physical object in the computation coordinate system.

For each target physical object, the target physical object may include a three-dimensional stereoscopic object, such as a furniture, an electric appliance, a potted plant, etc., and may further include a two-dimensional planar object, such as a wall, a door and a window, a desktop, a photo frame hung on a wall, and the like.

Therefore, in the present application, after determining the feature point of any target physical object, whether the target physical object is a three-dimensional object or a two-dimensional plane object may be analyzed based on the three-dimensional pose information of respective feature points of the target physical object, thereby determining the calibration representation of the target physical object.

The calibration representation of the target physical object may include a three-dimensional stereoscopic graph (denoted as a Box) and a two-dimensional planar graph (denoted as Plane) for surrounding the physical object.

Then, according to the calibration representation of the target physical object, in the present application, comprehensive analysis may be performed on respective feature points of the target physical object to determine at least one location point with a physical meaning in the calibration representation as the at least one spatial anchor point of the target physical object. Moreover, for each spatial anchor point of the target physical object, a plurality of boundary feature points related to the spatial anchor point may be found from respective feature points of the target physical object. Then, according to the three-dimensional pose information of each boundary feature point, the associated boundary information of the spatial anchor may be determined, to indicate the relevant pose information of the target physical object in the three-dimensional computer-generated environment. Then, each spatial anchor point of the target physical object and the associated boundary information of the spatial anchor form a calibration record, and the calibration records corresponding to respective spatial anchor points are combined to form calibration composition data of the target physical object in the computation coordinate system.

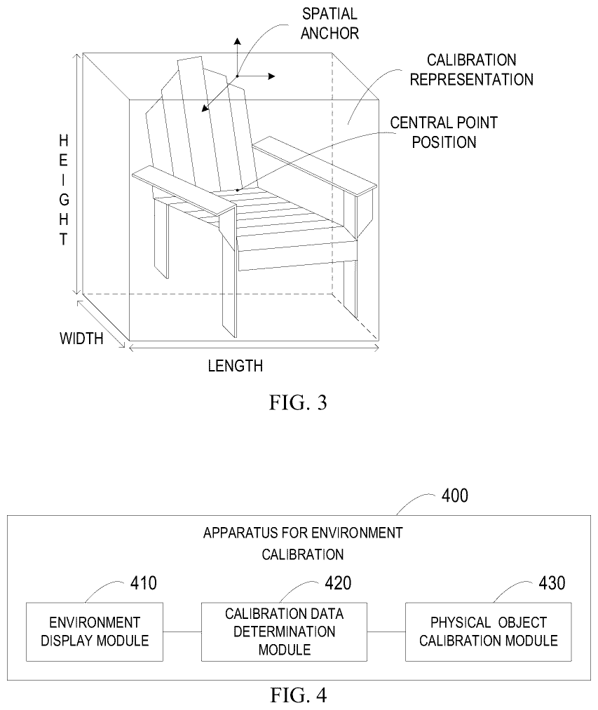

Taking the target physical object as a chair and the calibration representation as a three-dimensional stereoscopic graph as an example, when it is detected that the target physical object is a chair in the environmental depth map, boundary points in respective feature points of the chair may be used to determine an external cube of the chair. As shown in FIG. 3, based on the external cube of the chair, a virtual three-dimensional frame completely surrounding the chair may be formed as a calibration representation of the chair to represent the pose and size of the chair in the real environment.

As shown in FIG. 3, a central point in the upper surface of the virtual three-dimensional frame of the chair may be recorded as a spatial anchor of the chair, and three-dimensional pose information of the spatial anchor may be determined. Then, the spatial anchor is used as a local coordinate origin, information such as a center point location, length, width, height and the like of the virtual cube of the chair may be recorded as the boundary information associated with the spatial anchor point. The association boundary information of the spatial anchor and the spatial anchor is combined to obtain calibration composition data of the chair, so as to indicate the pose information of the chair in the three-dimensional computer-generated environment.

At S240, a coordinate transformation is performed on the calibration composition data by using the coordinate offset between the computation coordinate system and the rendering coordinate system, to obtain a calibration pose of the target physical object in the rendering coordinate system.

After the calibration composition data of any target physical object in the computation coordinate system is determined, since the virtual model after the target physical object is calibrated needs to be presented in the rendering coordinate system used by the front end, in order to avoid the situation that the calibration position of the target physical object deviates due to the inconsistency of the computation coordinate system and the rendering coordinate system, in the present application, the coordinate offset between the computation coordinate system and the rendering coordinate system may be used to perform corresponding pose coordinate transformation on the calibration composition data of the target physical object in the computation coordinate system, to determine the pose information of the target physical object in the rendering coordinate system. The pose information is used as the calibration pose of the target physical object in the rendering coordinate system, so as to generate the virtual model of the target physical object after calibration.

At S250, the calibration model of the target physical object in the rendering coordinate system is determined based on the calibration pose.

According to the calibration pose of the target physical object in the rendering coordinate system, information such as the position, the orientation, the object size, the spatial shape and the like of the target physical object in the rendering coordinate system can be analyzed, so that the virtual model of the target physical object in the rendering coordinate system after calibration is generated as the calibration model of the target physical object in the rendering coordinate system.

In some implementations, in order to ensure the calibration accuracy of the target physical object, and for the calibration model of the target physical object in the rendering coordinate system, in the present application, which may be determined by the following steps: presenting, based on the calibration pose, a preview model of the target physical object in the three-dimensional computer-generated environment; in response to calibration adjustment on the preview model, updating the calibration pose; and in response to calibration confirmation on the preview model, presenting, based on the updated calibration pose, the calibration model of the target physical object in the three-dimensional computer-generated environment.

After determining the calibration pose of the target physical object in the rendering coordinate system, in the present application, the virtual model of the target physical object may be presented in advance in the three-dimensional computer-generated environment as a preview model of the target physical object according to the information such as the position, the orientation, the object size, the spatial shape and the line of the target physical object in rendering coordinate system. The preview model is in an adjustable state and supports a user to perform a corresponding structure adjustment operation on it.

Since the display generation component of the electronic device presents the three-dimensional computer-generated environment in which the user is currently located, after presenting the preview model of the target physical object in the three-dimensional computer-generated environment, it can be determined whether the preview model is consistent with the target physical object by comparing the presentation difference between the target physical object in the real environment and the preview model of the target physical object. If the preview model of the target physical object and the target physical object have presentation differences, the user may be supported to perform corresponding structure adjustment on the preview model. Then, when the calibration adjustment on the preview model is detected, the target pose of the target physical object may be continuously updated according to the adjusted pose information of the preview model until the adjusted preview model of the target physical object is consistent with the target physical object.

When the preview model of the target physical object is consistent with the target physical object, it indicates that the preview model does not need to be adjusted again. Then, the user may perform a corresponding calibration confirmation on the preview model to indicate that the target physical object is calibrated. Therefore, when the calibration confirmation on the preview model is detected, the calibration model of the target physical object may be presented in the three-dimensional computer-generated environment according to information such as the object position, the orientation, the object size, the spatial shape and the like represented by the updated calibration pose, so that the calibration model of the target physical object can be consistent with the target physical object, thereby ensuring the calibration accuracy of the target physical object.

According to the technical solution provided by embodiments of the present application, the three-dimensional computer-generated environment is displayed via the display generation component of the electronic device, and calibration composition data of any target physical object in the computation coordinate system is determined in the three-dimensional computer-generated environment. Then, the calibration model of the target physical object in the rendering coordinate system used for calibration is determined based on the calibration composition data and the coordinate offset between the computation coordinate system and rendering calibration, so that accurate calibration of any target physical object is achieved, environment calibration adaptability in different application coordinate systems used in various scenes is ensured, position deviation occurring during environment calibration in different application coordinate systems is avoided, and the authenticity and effectiveness of environment calibration is improved.

FIG. 4 is a schematic block diagram of an apparatus for environment calibration according to embodiments of the present application, where the apparatus for environment calibration 400 may be configured at an electronic device that communicates with a display generation component and one or more input devices. As shown in FIG. 4, the apparatus 400 may include:
an environment display module 410 configured to display, via the display generation component, a three-dimensional computer-generated environment;
a calibration data determination module 420 configured to determine, in the three-dimensional computer-generated environment, calibration composition data of a target physical object in a computation coordinate system; and
a physical object calibration module 430 configured to determine a calibration model of the target physical object in a rendering coordinate system used for calibration, based on the calibration composition data and a coordinate offset between the computation coordinate system and the rendering coordinate system.

In some implementations, the calibration data determination module 420 may include:
a feature point determination unit configured to determine a feature point of the target physical object based on an environmental depth map corresponding to the three-dimensional computer-generated environment; and
a calibration data determination unit configured to determine the calibration composition data of the target physical object in the computation coordinate system, based on three-dimensional pose information of the feature point in the computation coordinate system.

In some implementations, the feature point determination unit may be specifically configured to:
perform feature analysis on the environmental depth map corresponding to the three-dimensional computer-generated environment, based on a target environment parameter of the three-dimensional computer-generated environment in the computation coordinate system, to obtain the feature point of the target physical object;
wherein the target environmental parameter is determined by an environmental input parameter for selecting the rendering coordinate system and the coordinate offset relationship between the computation coordinate system and the rendering coordinate system.

In some implementations, the calibration data determination unit may be specifically configured to:
determine a calibration representation of the target physical object based on the three-dimensional pose information of the feature point in the computation coordinate system; and
determine, based on the calibration representation, at least one spatial anchor point of the target physical object and boundary information associated with the spatial anchor point, to constitute the calibration composition data of the target physical object in the computation coordinate system.

In some implementations, the calibration representation of the target physical object comprises a three-dimensional stereoscopic graph and a two-dimensional planar graph for enclosing the target physical object.

In some implementations, the physical object calibration module 430 may include:
a calibration pose determination unit configured to perform a coordinate transformation on the calibration composition data by using the coordinate offset between the computation coordinate system and the rendering coordinate system, to obtain a calibration pose of the target physical object in the rendering coordinate system; and
a calibration model determination unit configured to determine, based on the calibration pose, the calibration model of the target physical object in the rendering coordinate system.

In some implementations, the calibration model determination unit may be specifically configured to:
present, based on the calibration pose, a preview model of the target physical object in the three-dimensional computer-generated environment;
in response to calibration adjustment on the preview model, update the calibration pose; and
in response to calibration confirmation on the preview model, present, based on the updated calibration pose, the calibration model of the target physical object in the three-dimensional computer-generated environment.

In some implementations, the apparatus for environment calibration 400 may further include:
a coordinate system configuration module configured to determine a plurality of pre-configured application coordinate systems, and recording a coordinate offset between the computation coordinate system and each of the application coordinate systems, to determine the coordinate offset between the computation coordinate system and the rendering coordinate system.

In embodiments of the present application, the three-dimensional computer-generated environment is displayed via the display generation component of the electronic device, and calibration composition data of any target physical object in the computation coordinate system is determined in the three-dimensional computer-generated environment. Then, the calibration model of the target physical object in the rendering coordinate system used for calibration is determined based on the calibration composition data and the coordinate offset between the computation coordinate system and rendering calibration, so that accurate calibration of any target physical object is achieved, environment calibration adaptability in different application coordinate systems used in various scenes is ensured, position deviation occurring during environment calibration in different application coordinate systems is avoided, and the authenticity and effectiveness of environment calibration is improved.

It should be understood that the apparatus embodiments and the method embodiments may correspond to each other, and similar descriptions may refer to the method embodiments. To avoid repetition, details are not described herein again. Specifically, the apparatus 400 shown in FIG. 4 may perform any method embodiment provided in the present application, and the foregoing and other operations and/or functions of each module in the apparatus 400 are respectively used to implement corresponding procedures in the methods in the embodiments of the present application.

The apparatus 400 in embodiments of the present application is described above from an angle of a functional module with reference to the accompanying drawings. It should be understood that the functional module may be implemented in hardware or may be implemented by using an instruction in a form of software, or may be implemented by combining hardware and software modules. Specifically, steps in the method embodiment in embodiments of the present application may be completed by using an integrated logic circuit of hardware in a processor and/or an instruction in a form of software, and steps of the method disclosed in embodiments of this the present may be directly reflected as execution of a hardware coding processor, or performed by combining hardware and software modules in a coding processor. Alternatively, the software module may be located in a mature storage medium in the art such as a random access memory, a flash memory, a read-only memory, a programmable read-only memory, an electrically erasable programmable memory, a register, and the like. The storage medium is located in the memory, the processor reads information in the memory, and completes the steps in the foregoing method embodiments in combination with hardware of the storage medium.

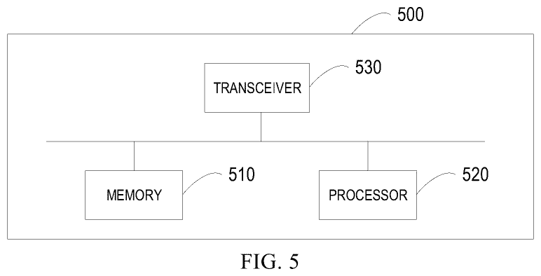

FIG. 5 is a schematic block diagram of an electronic device according to embodiments of the present application.

As shown in FIG. 5, the electronic device 500 may include:
a memory 510 and a processor 520, where memory 510 is configured to store a computer program, and transmit program code to the processor 520. In other words, the processor 520 may invoke and run the computer program from the memory 510 to implement the method in embodiments of the present application.

For example, the processor 520 may be configured to perform the foregoing method embodiments according to the instructions in the computer program.

In some embodiments of the present application, the processor 520 may include, but is not limited to: a general-purpose processor, a digital signal processor (DSP), an application specific integrated circuit (ASIC), a field programmable gate array (FPGA), another programmable logic device, a discrete gate or transistor logic device, a discrete hardware component, or the like.

In some embodiments of the present application, the memory 510 includes, but is not limited to: volatile memory and/or non-volatile memory. The non-volatile memory may be a read-only memory (ROM), a programmable read-only memory (programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which serves as an external cache. By way of example and not limitation, many forms of RAM are available, such as Static Random Access Memory (Static RAM, SRAM), Dynamic Random Access Memory (Dynamic RAM, DRAM), Synchronous Dynamic Random Access Memory (SDRAM), Double Data Rate SDRAM (DDR SDRAM), Enhanced SDRAM (ESDRAM), Synch link DRAM (SLDRAM), and Direct Rambus RAM (DR RAM).

In some embodiments of the present application, the computer program may be divided into one or more modules, and the one or more modules are stored in the memory 510 and executed by the processor 520 to complete the method provided in the present application. The one or more modules may be a series of computer program instruction segments capable of completing a specific function, and the instruction segment is used to describe an execution process of the computer program in the electronic device.

As shown in FIG. 5, the electronic device may further include: a transceiver 530 which may be connected to the processor 520 or the memory 510.

The processor 520 may control the transceiver 530 to communicate with another device, specifically, may send information or data to another device, or receive information or data sent by another device. The transceiver 530 may include a transmitter and a receiver. The transceiver 530 may further include an antenna, and there may be one or more antennas.

It should be understood that each component in the electronic device is connected to the bus system, where in addition to a data bus, the bus system further includes a power bus, a control bus, and a status signal bus.

The present application further provides a computer storage medium having a computer program stored thereon, and when the computer program is executed by a computer, the computer may perform the method in the foregoing method embodiments. In other words, embodiments of the present application further provides a computer program product including an instruction, and when the instruction is executed by a computer, the computer performs the method in the foregoing method embodiments.

When implemented by software, implementation can be made in the form of a computer program product completely or in part. The computer program product includes one or more computer instructions. The one or more computer program instructions, when loaded and executed on a computer, produce all or a part of the processes or functions described in the embodiments of the present application. The computer may be a general purpose computer, an application specific computer, a computer network, or any other programmable device. The computer instructions may be stored in a computer-readable storage medium or transmitted from one computer-readable storage medium to another computer-readable storage medium. For example, the one or more computer instructions may be transmitted from one website, computer, server, or data center to another website, computer, server, or data center in a wired manner (such as coaxial cable, optical fiber, digital subscriber line (DSL)) or a wireless manner (such as infrared, wireless, microwave, etc.). The computer-readable storage medium may be any usable medium that can be accessed by a computer or a data storage device such as a server or a data center integrated with one or more usable mediums. The usable medium may be a magnetic medium (for example, a floppy disk, a hard disk, a magnetic tape), an optical medium (for example, a digital video disc (DVD)), or a semiconductor medium (for example, a solid state disk (SSD)), etc.

It can be appreciated by those skilled in the art that the modules and the steps of the algorithm of examples described in combination with the embodiments disclosed herein may be implemented in electronic hardware or a combination of computer software and electronic hardware. These functions can be realized by hardware or software, depending on specific applications and design constraint conditions of the technical solution. For each specific application, the person skilled in the art can use different methods to implement the described functions, but such implementation should not be considered as going beyond the scope of the present application.

It is to be understood that the systems, apparatuses, and methods disclosed in several embodiments provided by the present application can be implemented in other ways. For example, the apparatus embodiments described above are merely exemplary. For example, the modules are merely divided based on logic functions. In practical implementation, the modules can be divided in other manners. For example, multiple modules or components can be combined or integrated into another system, or some features can be omitted or not executed. In addition, mutual coupling or direct coupling or communication connection described or discussed can be implemented through some interfaces, and indirect coupling or communication connection of apparatuses or modules may be electrical, mechanical or in other forms.

The modules illustrated as separate components may be or may not be separated physically, and components shown as modules may be or may not be physical modules, i.e., may be located at one position, or distributed onto multiple network units. It is possible to select some or all of the modules according to actual needs, for achieving the solution of the embodiment of the present application. For example, respective functional modules in respective embodiments of the present application can be integrated into one processing module, or be present separately and physically. It is also possible to integrate two or more modules into one module.

The above description merely illustrates specific implementations of the present application, and the scope of the present application is not limited thereto. Any change or replacement easily envisaged by those skilled in the art within the technical scope disclosed by the present application should fall into the protection scope of the present application. The protection scope of the present application is defined only by the claims.

I/We claim:

1. A method of environment calibration, comprising:
at an electronic device configured to communicate with a display generation component and one or more input devices:
displaying, via the display generation component, a three-dimensional computer-generated environment;
determining, in the three-dimensional computer-generated environment, calibration composition data of a target physical object in a computation coordinate system; and
determining a calibration model of the target physical object in a rendering coordinate system used for calibration, based on the calibration composition data and a coordinate offset between the computation coordinate system and the rendering coordinate system.

2. The method of claim 1, wherein the determining, in the three-dimensional computer-generated environment, calibration composition data of a target physical object in a computation coordinate system comprises:
determining a feature point of the target physical object based on an environmental depth map corresponding to the three-dimensional computer-generated environment; and
determining the calibration composition data of the target physical object in the computation coordinate system, based on three-dimensional pose information of the feature point in the computation coordinate system.

3. The method of claim 2, wherein the determining a feature point of the target physical object based on an environmental depth map corresponding to the three-dimensional computer-generated environment comprises:
performing feature analysis on the environmental depth map corresponding to the three-dimensional computer-generated environment, based on a target environment parameter of the three-dimensional computer-generated environment in the computation coordinate system, to obtain the feature point of the target physical object;
wherein the target environmental parameter is determined by an environmental input parameter for selecting the rendering coordinate system and the coordinate offset relationship between the computation coordinate system and the rendering coordinate system.

4. The method of claim 2, wherein the determining the calibration composition data of the target physical object in the computation coordinate system, based on three-dimensional pose information of the feature point in the computation coordinate system comprises:
determining a calibration representation of the target physical object based on the three-dimensional pose information of the feature point in the computation coordinate system; and
determining, based on the calibration representation, at least one spatial anchor point of the target physical object and boundary information associated with the spatial anchor point, to constitute the calibration composition data of the target physical object in the computation coordinate system.

5. The method of claim 4, wherein the calibration representation of the target physical object comprises a three-dimensional stereoscopic graph and a two-dimensional planar graph for enclosing the target physical object.

6. The method of claim 1, wherein the determining a calibration model of the target physical object in a rendering coordinate system used for calibration, based on the calibration composition data and a coordinate offset between the computation coordinate system and the rendering coordinate system comprises:
performing a coordinate transformation on the calibration composition data by using the coordinate offset between the computation coordinate system and the rendering coordinate system, to obtain a calibration pose of the target physical object in the rendering coordinate system; and
determining, based on the calibration pose, the calibration model of the target physical object in the rendering coordinate system.

7. The method of claim 6, wherein the determining, based on the calibration pose, the calibration model of the target physical object in the rendering coordinate system comprises:
presenting, based on the calibration pose, a preview model of the target physical object in the three-dimensional computer-generated environment;
in response to calibration adjustment on the preview model, updating the calibration pose; and
in response to calibration confirmation on the preview model, presenting, based on the updated calibration pose, the calibration model of the target physical object in the three-dimensional computer-generated environment.

8. The method of claim 1, further comprising:
determining a plurality of pre-configured application coordinate systems, and recording a coordinate offset between the computation coordinate system and each of the application coordinate systems, to determine the coordinate offset between the computation coordinate system and the rendering coordinate system.

9. An electronic device, comprising:
a processor, and
a memory configured to store a computer program,
wherein the processor is configured to invoke and run the computer program stored in the memory to implement operations comprising:
at an electronic device configured to communicate with a display generation component and one or more input devices:
displaying, via the display generation component, a three-dimensional computer-generated environment;
determining, in the three-dimensional computer-generated environment, calibration composition data of a target physical object in a computation coordinate system; and
determining a calibration model of the target physical object in a rendering coordinate system used for calibration, based on the calibration composition data and a coordinate offset between the computation coordinate system and the rendering coordinate system.

10. The electronic device of claim 9, wherein the determining, in the three-dimensional computer-generated environment, calibration composition data of a target physical object in a computation coordinate system comprises:
determining a feature point of the target physical object based on an environmental depth map corresponding to the three-dimensional computer-generated environment; and
determining the calibration composition data of the target physical object in the computation coordinate system, based on three-dimensional pose information of the feature point in the computation coordinate system.

11. The electronic device of claim 10, wherein the determining a feature point of the target physical object based on an environmental depth map corresponding to the three-dimensional computer-generated environment comprises:
performing feature analysis on the environmental depth map corresponding to the three-dimensional computer-generated environment, based on a target environment parameter of the three-dimensional computer-generated environment in the computation coordinate system, to obtain the feature point of the target physical object;
wherein the target environmental parameter is determined by an environmental input parameter for selecting the rendering coordinate system and the coordinate offset relationship between the computation coordinate system and the rendering coordinate system.

12. The electronic device of claim 10, wherein the determining the calibration composition data of the target physical object in the computation coordinate system, based on three-dimensional pose information of the feature point in the computation coordinate system comprises:
determining a calibration representation of the target physical object based on the three-dimensional pose information of the feature point in the computation coordinate system; and
determining, based on the calibration representation, at least one spatial anchor point of the target physical object and boundary information associated with the spatial anchor point, to constitute the calibration composition data of the target physical object in the computation coordinate system.

13. The electronic device of claim 12, wherein the calibration representation of the target physical object comprises a three-dimensional stereoscopic graph and a two-dimensional planar graph for enclosing the target physical object.

14. The electronic device of claim 9, wherein the determining a calibration model of the target physical object in a rendering coordinate system used for calibration, based on the calibration composition data and a coordinate offset between the computation coordinate system and the rendering coordinate system comprises:
performing a coordinate transformation on the calibration composition data by using the coordinate offset between the computation coordinate system and the rendering coordinate system, to obtain a calibration pose of the target physical object in the rendering coordinate system; and
determining, based on the calibration pose, the calibration model of the target physical object in the rendering coordinate system.

15. The electronic device of claim 14, wherein the determining, based on the calibration pose, the calibration model of the target physical object in the rendering coordinate system comprises:
presenting, based on the calibration pose, a preview model of the target physical object in the three-dimensional computer-generated environment;
in response to calibration adjustment on the preview model, updating the calibration pose; and
in response to calibration confirmation on the preview model, presenting, based on the updated calibration pose, the calibration model of the target physical object in the three-dimensional computer-generated environment.

16. The electronic device of claim 9, the operations further comprising:
determining a plurality of pre-configured application coordinate systems, and recording a coordinate offset between the computation coordinate system and each of the application coordinate systems, to determine the coordinate offset between the computation coordinate system and the rendering coordinate system.

17. A non-transitory computer-readable storage medium storing a computer program, wherein the computer program causes a computer to perform operations comprising:
at an electronic device configured to communicate with a display generation component and one or more input devices:
displaying, via the display generation component, a three-dimensional computer-generated environment;
determining, in the three-dimensional computer-generated environment, calibration composition data of a target physical object in a computation coordinate system; and
determining a calibration model of the target physical object in a rendering coordinate system used for calibration, based on the calibration composition data and a coordinate offset between the computation coordinate system and the rendering coordinate system.

18. The non-transitory computer-readable storage medium of claim 17, wherein the determining, in the three-dimensional computer-generated environment, calibration composition data of a target physical object in a computation coordinate system comprises:
determining a feature point of the target physical object based on an environmental depth map corresponding to the three-dimensional computer-generated environment; and
determining the calibration composition data of the target physical object in the computation coordinate system, based on three-dimensional pose information of the feature point in the computation coordinate system.

19. The non-transitory computer-readable storage medium of claim 18, wherein the determining a feature point of the target physical object based on an environmental depth map corresponding to the three-dimensional computer-generated environment comprises:
performing feature analysis on the environmental depth map corresponding to the three-dimensional computer-generated environment, based on a target environment parameter of the three-dimensional computer-generated environment in the computation coordinate system, to obtain the feature point of the target physical object;
wherein the target environmental parameter is determined by an environmental input parameter for selecting the rendering coordinate system and the coordinate offset relationship between the computation coordinate system and the rendering coordinate system.

20. The non-transitory computer-readable storage medium of claim 18, wherein the determining the calibration composition data of the target physical object in the computation coordinate system, based on three-dimensional pose information of the feature point in the computation coordinate system comprises:
determining a calibration representation of the target physical object based on the three-dimensional pose information of the feature point in the computation coordinate system; and
determining, based on the calibration representation, at least one spatial anchor point of the target physical object and boundary information associated with the spatial anchor point, to constitute the calibration composition data of the target physical object in the computation coordinate system.
